(19) United States
(12) Patent Application Publication
(10) Pub. No.: US 2016/0318196 A1
(43) Pub. Date: Nov. 3, 2016

(54) COMBINATION CUT AND TWIST OPENER

(71) Applicant: VELAASA LLC, Woodbury, MN (US)

(72) Inventor: Lynden Reder, Woodbury, MN (US)

(21) Appl. No.: 15/142,400

(22) Filed: Apr. 29, 2016

Related U.S. Application Data
(60) Provisional application No. 62/155,135, filed on Apr. 30, 2015.

(51) Int. Cl. B26B 11/00

(52) U.S. Cl. CPC B26B 11/00

(57) ABSTRACT

Openers for opening a twist cap of a bottle while simultaneously cutting a seal adjacent the twist cap are disclosed. An example opener may include a body a first arm and a second arm projecting therefrom. The body may have an inner curved surface. The first arm and the second arm may be designed to be moved closer to one another during use of the opener. A first gripping region may be defined along the inner curved surface. The first gripping region may be designed to engage and grip the twist cap during use of the opener. A plurality of cutting members may be positioned along the inner curved surface. The cutting members may be designed to pierce and cut the seal during use of the opener.

### CROSS-REFERENCE TO RELATED APPLICATIONS

This application claims priority under 35 U.S.C. §119 to U.S. Provisional Application Ser. No. 62/155,135, filed Apr. 30, 2015, the entirety of which is incorporated herein by reference.

### TECHNICAL FIELD

The present disclosure pertains to openers.

### BACKGROUND

A wide variety of openers have been developed. Of the known openers, each has certain advantages and disadvantages. There is an ongoing need to provide alternative openers as well as alternative methods for manufacturing and using openers.

### BRIEF DESCRIPTION OF THE DRAWINGS

The disclosure may be more completely understood in consideration of the following detailed description of various embodiments of the disclosure in connection with the accompanying drawings, in which:

FIG. 1 is a perspective view of an example opener.

FIG. 2 is a top view of an example opener.

FIG. 3 is a bottom view of an example opener.

FIG. 4 is a side view of an example opener.

FIG. 5 is a side view of an example opener.

FIG. 6 is a perspective view of an example opener.

FIG. 7 is a top view of an example opener.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The drawings, which are not necessarily to scale, depict illustrative embodiments and are not intended to limit the scope of the disclosure.

A variety of containers exist for the packaging of consumer liquids, beverages and/or drinks. In some instances, the container and/or packaging includes a two-piece system including a cap (e.g. twist off) coupled to a bottle. Further, in some instances, a unitary sheet of foil and/or a plastic seal may extend around both the cap and the bottle. In order to remove the cap, a user may have to cut, slice and/or tear the seal to disengage the cap from the bottle. In some instances, it may be desirable to grip and twist the cap and foil seal with sufficient force such that both the cap and the seal are removed from the bottle at the same time. For example, in some instances it may be desirable to remove both the seal and the cap of a 5-HOUR ENERGY™ drink and/or other similar energy drinks or the like. In particular, the twist cap of a miniature energy drink bottle may be sufficiently small (e.g., having a diameter less than about 1 inch or about 0.875±0.1 inches) such that it may be difficult for a user to easily use their hands to twist off the cap. In other words, the size of the twist cap and the force required to twist a cap of such dimensions may require a reasonably high amount of force, making it challenging to open the bottle while simultaneously cutting the plastic seal around the bottle cap. Therefore, it may be desirable to utilize materials and/or design a dual combination opener that can both cut a foil/plastic seal and remove a bottle cap simultaneously.

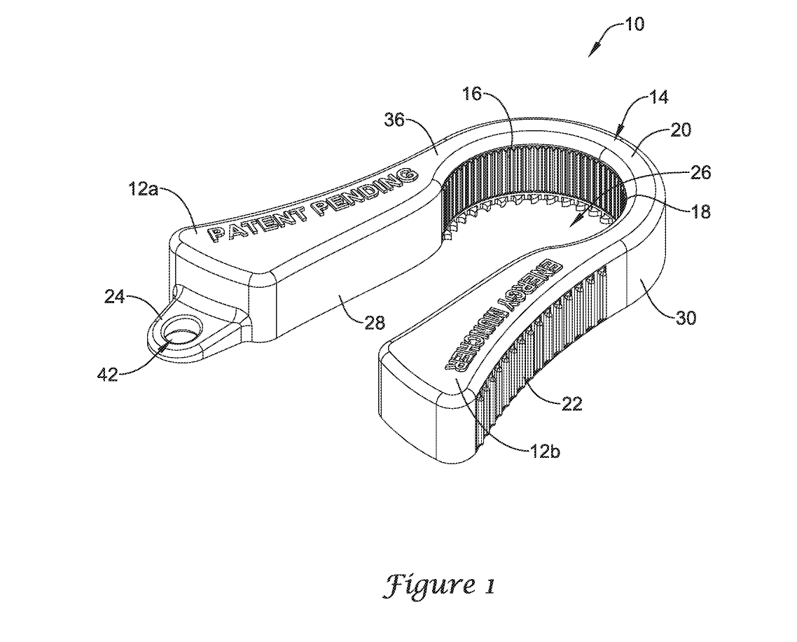

FIG. 1 is a schematic view of an example dual combination cutting and twisting opener 10. Opener 10 may be a unitary body that includes opener body portion 14 coupled to gripping arms 12A and 12B. Gripping arms 12A and 12B may extend away from body portion 14. Further, one or more attachment members 24 may extend away from gripping arm 12A and/or 12B. Opener 10 may include an interior surface 28 which includes the interior surface of gripping arms 12A, 12B and body portion 14. Similarly, opener 10 may include an exterior facing surface 30 defined by an exterior surface of gripping arms 12A, 12B and body portion 14.

Body portion 14 may include curved body wall 20. As stated above, interior surface 28 may extend along and be partially defined by the inner surface of the body wall 20. In some instances, body wall 20 may include one or more cap gripping surfaces 16. Cap gripping surface 16 may include projections, textures, ridges, ribs, grooves, channels, cuts, notches, flutes or the like extending along a portion or all of interior surface 28.

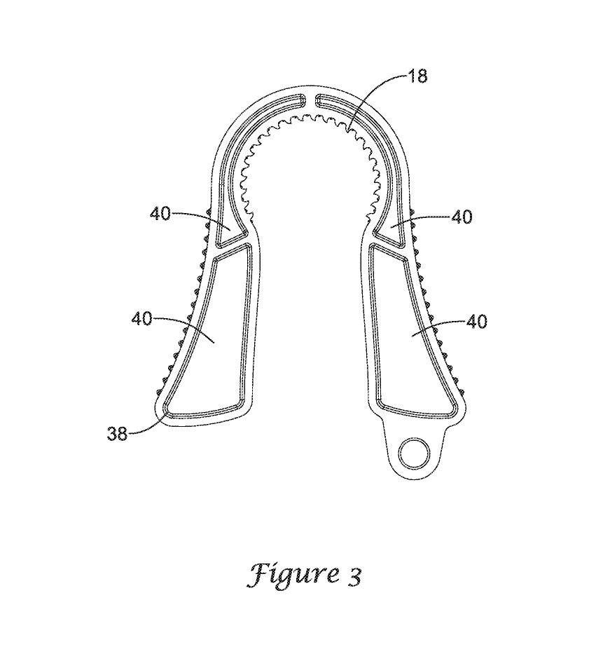

As shown in FIG. 1, cap gripping surface 16 may extend from a bottom surface 38 (shown in FIG. 3) to a top surface 36 of interior surface 28 of body portion 14. In other words, it is contemplated that in some embodiments gripping surface 16 may extend the entire “thickness” of body portion 14. Gripping surface 16 may be designed to be able to grip a variety of materials. For example, gripping surface 16 may designed to grip and/or embed in a variety of polymer or metallic materials. The ability to grip and/or embed in a variety of materials may allow a user to more easily apply leverage via opener 10 to twist and remove a bottle cap, for example. This may also make it easier to twist and remove a bottle cap while simultaneously cutting a seal disposed around the bottle cap.

In some instances, body portion 14 may include one or more teeth members 18. As shown in FIG. 1, teeth members 18 may be positioned and aligned along the bottom surface 38 (e.g. the bottom “edge”) of body 14. Further, teeth 18 may extend along a portion or all of the interior surface 28. Teeth members 18 may project away from interior surface 28.

It is contemplated that teeth members 18 may be a variety of shapes. For example, teeth 18 illustrated in FIGS. 1-3 may bear some resemblance to the shape of a shark fin or, similarly, the teeth of a circular saw blade. In other words, an individual tooth 18 may extend away from interior surface 18 and project to a “tip” or “point.” Further, it is contemplated that teeth 18 may assume a variety of shapes. For example, teeth 18 may be square, triangular, hooked, angled, rounded, beveled, scalloped, pegged, slanted or the like.

While the above discussion described teeth 18 as being positioned along the bottom edge of body 14, it is contemplated that teeth 18 may be positioned at other locations along interior surface 28. For example, teeth 18 may be positioned along a top edge, the middle portion or dispersed intermittently along interior surface 28. As described above, the alignment of multiple teeth 18 permits opener 10 to cut and/or slice a foil or plastic seal, for example, as opener 10 is twisted to simultaneously remove cap (discussed above).

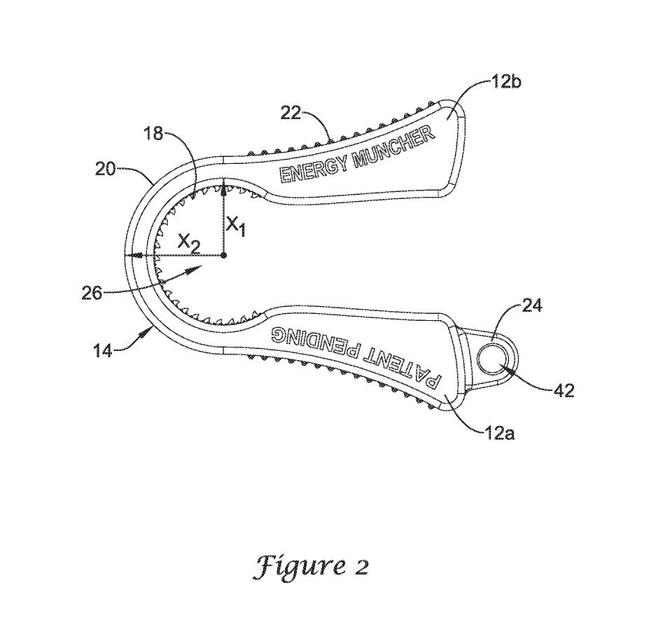

As shown in FIGS. 1 and 2, curved body wall 20 may define a central opening 26. As shown in FIG. 2, central opening 26 may be substantial circular and include an inner radius identified in FIG. 2 as dimension “X1.” In some embodiments, radius X1 may be about 0.3-0.6 inches, or about 0.4-0.5 inches, or about 0.483 inches.

Additionally, body portion 14 may include an outer radius identified in FIG. 2 as dimension “X2.” In some embodiments, radius X2 may be about 0.4-0.8 inches, or about 0.6-0.7 inches, or about 0.683 inches.

Central opening 26 may be sized to accept a variety of cap sizes and configurations. Central opening 26 may define a portion of an arc or circle. For example, as shown in FIG. 2, central opening 26 extends approximately 270 degrees of a complete circle. It is contemplated that circular opening 26 could extend more or less than the partial circle shown in FIG. 2, depending on the particular application that the opener was designed to accommodate.

As shown in FIGS. 1 & 2, body portion 14 may be coupled to gripping arms 12A and 12B. Gripping arms 12A and 12B may be substantially parallel to one another. In particular, interior surface 28 of gripping arms 12A and 12B may be substantially parallel (as shown in FIG. 2). By contrast, the exterior surface 30 of gripping arms 12A and 12B may widen (e.g. flare) from the point at which gripping arms 12A and 12B are coupled to body portion 14 to the end of the gripping arm 12A/12B.

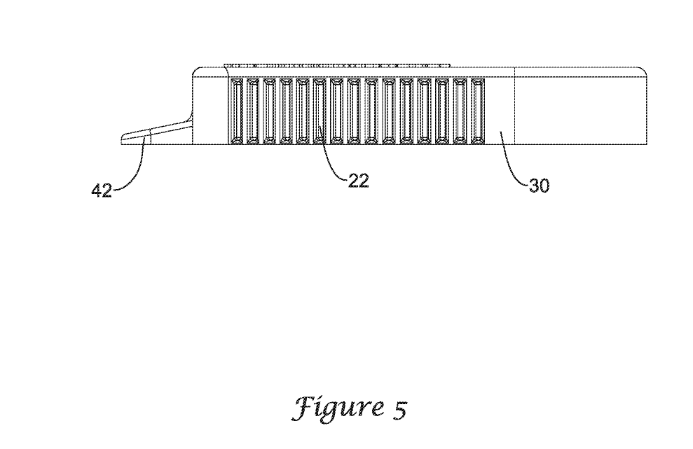

Gripping arms 12A & 12B may include a finger gripping surface 22 (shown in FIGS. 1, 4 and 5). In some embodiments, finger gripping surface 22 may be substantially similar to the gripping surface describe above with respect to cap gripping surface 16. For example, finger gripping surface 22 may include projections, textures, ridges, ribs, grooves, channels, cuts, notches, flutes or the like extending along a portion or all of exterior surface 30. Exterior surface 30 may include an ergonomic shape. The ergonomic shape may be one that follows the contours of a user's finger.

Additionally, FIGS. 1 & 2 show an attachment member 24 extending from and end of gripping arm 12A. While FIGS. 1 & 2 show attachment member extending from gripping arm 12A, it is contemplated that attachment member may extend from gripping arm 12B or any other portion of opener 10. In some instances, attachment member may allow opener 10 to be coupled, clipped and/or attached to a key ring or the like. As shown, attachment member includes an attachment opening 42. Attachment opening 42 may be sized to permit a variety of different size key rings, etc. to attach to opener 10. While shown as a circle in FIGS. 1 & 2, it is contemplated that attachment opening 42 may include other shapes. For example, attachment opening 42 may be a triangle, oval, or the like.

FIG. 3 shows bottom view of opener 10. Opener 10 may include one or more cavities 40. Cavities 40 may be defined as voids, recesses, etc. in which material is removed from opener 10. As shown in FIG. 3, cavities 40 may be separated from one another. For example, FIG. 3 shows four independent cavities 40.

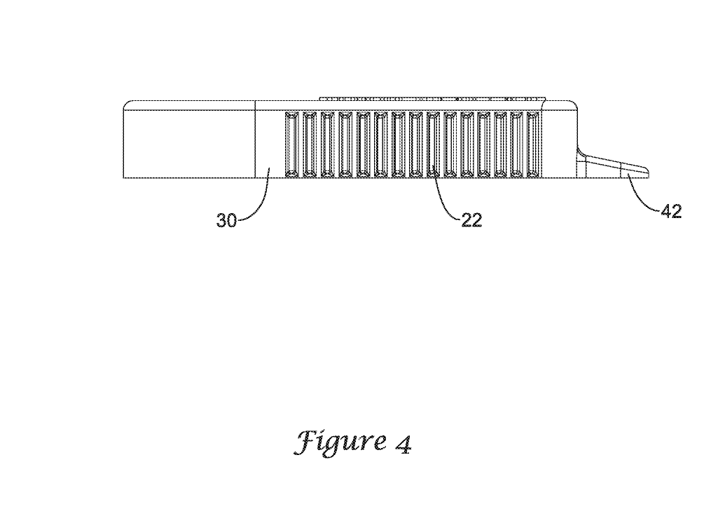

FIGS. 4 & 5 show side views of opener 10. As shown in each of FIGS. 4 & 5, finger gripping surfaces 22 may extend along a portion of the exterior surface 30 of opener 10.

In some instances, removing the cap and foil seal of a bottle simultaneously may include inserting the cap (along with the foil seal) into central opening 26. In some instances, the thickness of the opener 10 may be designed such that when the cap is inserted into central opening 26, teeth 18 may be aligned with the bottom of the cap. In other instances, teeth 18 may be aligned at a different location. After inserting the cap into central opening 26, a user may then “squeeze” gripping arms 12A & 12B such that gripping arms move toward each another. The movement of gripping arms toward one another may reduce the radius of central opening 26. This reduction in radius may effectively “tighten” opener 10 around an example cap. Once tightened, a user may spin the “ungripped” portion of the example container (e.g. bottle). Opener 10, through the gripping action of gripping surface 16 and the cutting action of teeth 18, may then effectively hold the cap stationary while the remainder of the container is twisted relative to the cap. This action may not only untwist the cap, but may also simultaneously cut the foil seal at the location where teeth 18 are aligned.

Dimensions of opener 10 (as shown in FIGS. 1-5) may include a length of about 1-5 inches, or about 2-3 inches, or about 2.718 inches. The opening may have a width of about 0.5-1.5 inches, or about 0.6-1 inches, or about 0.8 inches. The width across arms 12A/12B may be about 1-4 inches, or about 1.5-2.5 inches, or about 2.146 inches. The height of opener 10 may be about 0.2-0.8 inches, or about 0.3-0.5 inches, or about 0.4 inches. These are just examples.

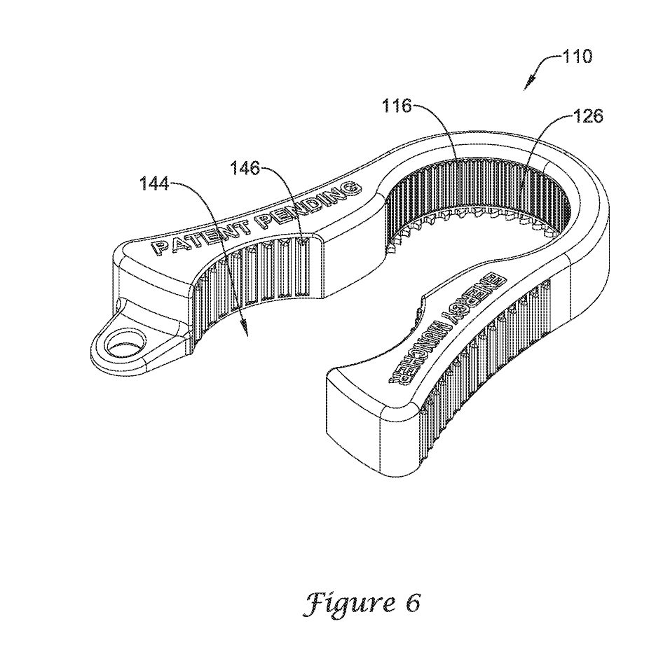

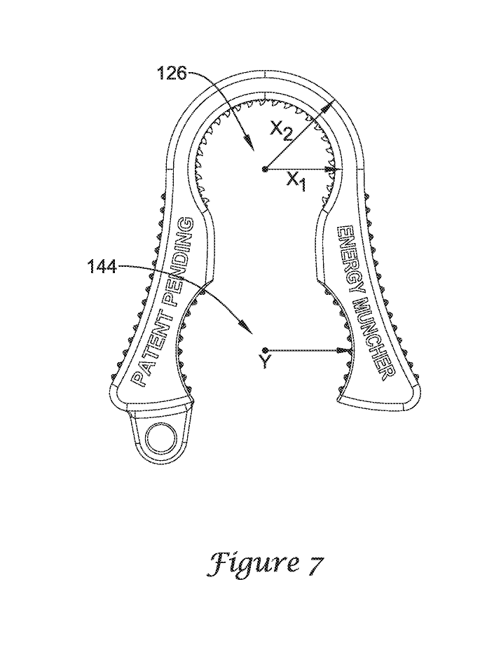

FIGS. 6-7 shows an alternative opener 110. As shown, opener 110 may include a secondary opening 144. As shown, secondary opening 144 may be positioned adjacent to central opening 126. Secondary opening 144 may be similarly designed and perform substantially similar to central opening 126. For example, secondary opening 144 may include secondary gripping surface 146. Secondary gripping surface 146 may be similar to cap gripping surface 116.

Opening 126 may be sized to include a radius X1 of about 0.3-0.6 inches, or about 0.4-0.5 inches, or about 0.483 inches (e.g., similar to what is shown in FIG. 2). Secondary opening 144 may include a radius “Y”. In some embodiments, radius Y may be about 0.3-0.8 inches, or about 0.5-0.7 inches, or about 0.600 inches.

In some instances, radius “Y” may be larger than the radius “X1” of central opening 126. It is contemplated that secondary opening 144 may be sized to facilitate the removal of caps different in diameter to that of the caps designed to be removed by central opening 126. For example, secondary opening 144 may be sized to remove the caps of a larger bottle (e.g. water bottle, soda, beer, etc.). In other instances, radius “Y” may be the same size or smaller than the radius “X1”. Secondary opening 144 may include a gripping surface. In some of these and in other instances, secondary opening 144 may include teeth (not shown), similar to teeth 18. Alternatively, secondary opening 144 may be free of teeth and, instead, may only include the gripping surface for gripping the cap of a bottle.

Opener 110 and/or other components of opener 110 may be made from a metal or polymer (some examples of which are disclosed below), a metal-polymer composite, combinations thereof, and the like, or other suitable material.

Dimensions of opener 110 (as shown in FIG. 6) may include a length of about 1-5 inches, or about 2-3 inches, or about 2.718 inches. The opening may have a width of about 0.5-1.5 inches, or about 0.6-1.2 inches, or about 0.996 inches. The width across arms 12A/12B may be about 1-4 inches, or about 1.5-2.5 inches, or about 2.146 inches. The height of opener 110 may be about 0.2-0.8 inches, or about 0.3-0.5 inches, or about 0.4 inches. The distance between the center of opening 126 and opening 144 may be about 0.5-2.5 inches, or about 1-1.5 inches, or about 1.25 inches. These are just examples.

Opener 10 and 110 described herein may be made from a polymer or other suitable material. Some examples of suitable polymers may include polytetrafluoroethylene (PTFE), ethylene tetrafluoroethylene (ETFE), fluorinated ethylene propylene (FEP), polyoxymethylene (POM, for example, DELRIN® available from DuPont), polyether block ester, polyurethane (for example, Polyurethane 85A), polypropylene (PP), polyvinylchloride (PVC), polyether-ester (for example, ARNITEL® available from DSM Engineering Plastics), ether or ester based copolymers (for example, butylene/poly(alkylene ether) phthalate and/or other polyester elastomers such as HYTREL® available from DuPont), polyamide (for example, DURETHAN® available from Bayer or CRISTAMID® available from Elf Atochem), elastomeric polyamides, block polyamide/ethers, polyether block amide (PEBA, for example available under the trade name PEBAX®), ethylene vinyl acetate copolymers (EVA), silicones, polyethylene (PE), Marlex high-density polyethylene, Marlex low-density polyethylene, linear low density polyethylene (for example REXELL®), polyester, polybutylene terephthalate (PBT), polyethylene terephthalate (PET), polytrimethylene terephthalate, polyethylene naphthalate (PEN), polyetheretherketone (PEEK), polyimide (PI), polyetherimide (PEI), polyphenylene sulfide (PPS), polyphenylene oxide (PPO), poly paraphenylene terephthalamide (for example, KEVLAR®), polysulfone, nylon, nylon-12 (such as GRILAMID® available from EMS American Grilon), perfluoro(propyl vinyl ether) (PFA), ethylene vinyl alcohol, polyolefin, polystyrene, epoxy, polyvinylidene chloride (PVdC), poly(styrene-b-isobutylene-b-styrene) (for example, SIBS and/or SIBS 50A), polycarbonates, ionomers, biocompatible polymers, other suitable materials, or mixtures, combinations, copolymers thereof, polymer/metal composites, and the like.

Forming the openers disclosed herein may include a molding (e.g., injection molding), casting, 3-D printing, or other suitable processes.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. An opener for opening a twist cap of a bottle while simultaneously cutting a seal adjacent the twist cap, the opener comprising:
a body a first arm and a second arm projecting therefrom;
wherein the body has an arcuate shape that defines an inner curved surface and an outer curved surface;
wherein the first arm and the second arm are designed to be moved closer to one another during use of the opener;
wherein the inner curved surface has a first radius prior to the first arm and the second arm being moved closer to one another and a second radius after the first arm and the second arm are moved closer to one another;
a first gripping region defined along the inner curved surface, the first gripping region being designed to engage and grip the twist cap during use of the opener;
a plurality of cutting members positioned along the inner curved surface, the cutting members being designed to pierce and cut the seal during use of the opener; and
a finger gripping surface disposed along the first arm, the second arm, or both.

2. The opener of claim 1, wherein the first radius is 0.3-0.6 inches.

3. The opener of claim 1, wherein the first radius is 0.4-0.5 inches.

4. The opener of claim 1, wherein the first radius is 0.483 inches.

5. The opener of claim 1, wherein the plurality of cutting members includes a plurality of teeth that terminate in a point.

6. The opener of claim 1, further comprising an attachment member coupled to the first arm.

7. The opener of claim 6, wherein the attachment member includes an attachment opening, the attachment opening being designed to allow the opener to be attached to a key ring.

8. The opener of claim 1, wherein the first arm, the second arm, or both have a secondary gripping surface.

9. The opener of claim 8, wherein the secondary gripping surface defines a second opening between the first arm and the second arm.

10. An opener for opening a twist cap of a bottle while simultaneously cutting a seal adjacent the twist cap, the opener comprising:
a body a first arm and a second arm projecting therefrom;
wherein a first opening is defined adjacent to the body, the first arm, and the second arm;
wherein the first arm and the second arm are designed to be moved closer to one another during use of the opener to change the size, shape, or both of the opening;
wherein the opening has a first radius of 0.4-0.5 inches such that the opener can be used to open a bottle cap with a diameter of less than 1.0 inches;
a first gripping region defined along the body and facing the opening, the first gripping region being designed to engage and grip the twist cap during use of the opener; and
a plurality of cutting members positioned adjacent to the first gripping region, the cutting members being designed to pierce and cut the seal during use of the opener.

11. The opener of claim 10, wherein the plurality of cutting members includes a plurality of teeth that terminate in a point.

12. The opener of claim 10, further comprising an attachment member coupled to the first arm.

13. The opener of claim 12, wherein the attachment member includes an attachment opening, the attachment opening being designed to allow the opener to be attached to a key ring.

14. The opener of claim 10, wherein the first arm, the second arm, or both have one or more outer gripping surfaces.

15. The opener of claim 10, wherein a second opening is defined adjacent to the body, the first arm, and the second arm and positioned adjacent to the first opening.

16. The opener of claim 15, wherein the second opening has a second radius different from the first radius.

17. The opener of claim 16, wherein the second radius is 0.3-0.8 inches.

18. The opener of claim 16, wherein the second radius is 0.5-0.7 inches.

19. The opener of claim 16, wherein the second radius is 0.6 inches.

20. An opener, comprising:
a body a first arm and a second arm projecting therefrom;
wherein a first opening is defined adjacent to the body, the first arm, and the second arm;
wherein the first arm and the second arm are designed to be moved closer to one another during use of the opener to change the size, shape, or both of the opening;
wherein the opening has a first radius of 0.4-0.5 inches such that the opener can be used to open a twist bottle cap for a miniature energy drink bottle with a diameter of less than 1.0 inches;
a gripping region defined along the body and facing the opening, the gripping region being designed to engage and grip the twist cap during use of the opener; and
a plurality of teeth positioned adjacent to the gripping region, the teeth being designed to pierce and cut the plastic seal during use of the opener.
